(19) United States
(12) Patent Application Publication
(10) Pub. No.: US 2026/0185577 A1
(43) Pub. Date: Jul. 2, 2026

(54) FRICTION BRAKE UNIT, DRIVE BRAKE UNIT AND VEHICLE

(71) Applicant: AUMOVIO Germany GmbH, Frankfurt am Main (DE)

(72) Inventors: Adrian Messner, Mainz (DE); Jens Bacher, Frankfurt am Main (DE)

(73) Assignee: AUMOVIO Germany GmbH, Frankfurt am Main (DE)

(21) Appl. No.: 19/438,667

(22) Filed: Jan. 2, 2026

(30) Foreign Application Priority Data
Jan. 2, 2025 (DE) 10 2025 100 012.3

(51) Int. Cl. F16D 65/18; B60T 13/74; F16D 121/24; F16D 125/02

(52) U.S. Cl. CPC F16D 65/18; B60T 13/745; F16D 2121/24; F16D 2125/02

(57) ABSTRACT

A friction brake unit for a drive brake unit comprises at least two components which can be electrically connected to a vehicle. The friction brake unit comprises a connection element which has a common connection geometry for the at least two components which can be electrically connected to a vehicle. A drive brake unit comprises a wheel-integrated electrical motor and such a wheel-integrated friction brake unit, and a vehicle comprises at least two drive brake units of this type.

### TECHNICAL FIELD

The present embodiments relate to a friction brake unit for a drive brake unit, wherein the friction brake unit comprises at least one brake actuator for actuating the friction brake unit and generating a braking torque and to a vehicle comprising at least two of the drive brake units.

### BACKGROUND

In the context of this application, a drive brake unit may be understood as meaning a combination of an electrical motor and a friction brake unit.

A drive brake unit of said type is known for example from KR20230021347A, in which a disk brake with a fixed caliper is combined with a wheel-integrated electrical motor. The drive brake unit has a plurality of connections for the power supply, for the signal connection of the electrical motor, for cooling the drive brake unit, and hydraulic lines for the brake caliper.

When integrating friction brakes and electric motors to form wheel-integrated drive brake units, as described, it quickly comes to the point where a large number of power supply lines, signal lines and fluid lines have to be connected in a very small space, which then compete with the wheel suspension and suspension for installation space.

### SUMMARY

Accordingly, this object is achieved by a friction brake unit, a drive brake unit and a vehicle as disclosed herein. Accordingly, a friction brake unit is provided, in which the friction brake unit comprises a connection element which has a common connection geometry for the at least two components which can be electrically connected to a vehicle. In this way, at least some of the electrical connection lines can be consolidated into common cables or cable harnesses. Furthermore, the position of the connection geometry can be varied within certain limits and thus adapted to the spatial conditions in the region of the stub axle and of the wheel suspension, such that the cable(s) to be connected to the connection geometry can be connected with the least possible installation space requirement. Assembly and servicing are thus also simplified.

The term “component which is electrically connectable to a vehicle” is to be understood as meaning that the component requires connection to a power supply and/or an electrical signal connection in order to function as intended.

In this document, the terms “motor axis of rotation”, “axially” or “axial direction” are to be understood as meaning the direction parallel to the axis of rotation of the vehicle wheel or of the drive rotor and “radial” or “radial direction” is to be understood as meaning the direction or directions perpendicular to said axis of rotation. The term circulation/circumferential direction refers to the tangential directions along imaginary circular paths with a constant radius, about the motor axis of rotation in planes perpendicular to the motor axis of rotation.

The connection geometry may be configured such that at least two components can be connected to the vehicle via a single cable. This also simplifies the installation.

In one embodiment, a component which is electrically connectable to a vehicle is an electrically actuatable parking brake device. Depending on the type of parking brake device involved, in the prior art it is possible for multiple electrical cables to be connected to the friction brake unit. The embodiments offer corresponding for a friction brake advantages unit with integrated parking brake device during installation and maintenance.

The electrically actuatable parking brake device may comprise a parking brake actuator which is integrated into a hydraulically actuatable service brake actuator. Such service brakes with an integrated parking brake device have additional components which are to be electrical connected to the vehicle.

The electrically actuatable parking brake device may be integrated into an electromechanically actuatable service brake actuator as a transmission lock. Compared to hydraulic brakes, such fully electrical friction brake units have at least an additional power supply and, in many cases, additional signal and sensor lines which, in the prior art, would require separate cable connections.

In one embodiment, a component that can be electrically connected to a vehicle is a lining wear indicator. A visual inspection of brake lining wear may not be possible depending on the design of the drive brake unit. A lining wear indicator may however be necessary for safety reasons, even if the friction brake unit is designed to last the life of the drive brake unit (i.e., there is no need to replace the brake lining in the normal situation). Correspondingly, such a friction brake unit benefits from the solution since the additional cable connection can be consolidated.

A component which is electrically connectable to a vehicle may be a braking force sensor or braking torque sensor. However, these sensors can also be connected to a local control unit. If not, the friction brake unit comprising a sensor benefits from the proposed solution.

The connection element may be formed as a housing cover, which is a constituent part of a friction brake housing. On the one hand, this makes it possible to consolidate the component connections for the components which are electrically connectable to a vehicle in the housing cover. On the other hand, housing covers adapted according to the friction brake unit can be provided in order to consolidate the connection of different components.

In one embodiment, the connection element comprises, on a side facing toward the friction brake unit, intermediate geometries for at least two of the components which are electrically connectable to a vehicle and which are connectable to component connections of the components, wherein the electrical lines are merged by the intermediate geometries in the connection element in the common connection geometry. If the connection element is a housing cover of a friction brake housing, the intermediate geometries can be arranged on the inner side of the housing cover, whereas the common connection geometry is arranged on an outer side (facing toward the vehicle) of the friction brake housing.

A friction brake housing of the friction brake unit may comprise an elastically deformable seal element which permits a movement of the friction brake housing in the course of an actuation of the brake actuator. Such a solution can be advantageous if the installation space around the friction brake is very tight but sealing of the friction brake unit is nevertheless desired. The movement of the friction brake housing during an actuation of the brake actuator may for example be an elastic deformation in the course of an actuation process of the brake actuator. However, it is also possible that the movement of the friction brake housing during actuation of the brake actuator describes a long-term movement of the friction brake housing as a result of wear on the brake linings. Thus, in the case of significantly worn brake lining, the brake actuator has a longer maximum travel than in the case of new brake linings, which has a corresponding influence on the deformation of the friction brake housing.

The connection element may be arranged movably together with an elastically deformable seal element.

The friction brake unit may be a disk brake having a brake caliper designed as a floating caliper.

The object is furthermore achieved by a drive brake unit comprising a wheel-integrated electrical motor and a wheel-integrated friction brake unit according to any one of the preceding embodiments, wherein the friction brake unit may be arranged so as to at least partially overlap axially with the electrical motor along the motor axis of rotation.

Preferably, a friction brake housing of the friction brake unit is sealingly connected to a stator component of the wheel-integrated electrical motor, thus substantially preventing an escape of brake dust from the drive brake unit. For this purpose, the friction brake unit can be arranged in a sufficiently large friction brake housing, thus enabling a full axial stroke of the brake actuator within the friction brake housing. A seal element between connection element and stator component can then have merely a sealing function without having to permit the axial stroke of the friction brake housing. Alternatively, it is however also possible for an elastically deformable seal element to be provided between the connection element and the stator component, which seal element permits elastic deformation of the friction brake housing during an actuation of the brake actuator. “Substantially prevented” can be understood here to mean that at least half, e.g. over 90%, of the brake dust is retained.

In one embodiment, the electrical motor is a double-rotor radial flux motor, in which a drive stator is arranged in a radial direction between an external drive rotor and an internal drive rotor, wherein the drive stator comprises coils for generating a magnetic field. Permanent magnets facing toward the drive stator may respectively be arranged on the external drive rotor and internal drive rotor. Such wheel-integrated electrical motors have a high average efficiency (even in the low-load range). The external drive rotor and the internal drive rotor may be connected via a rotor base. The rotor base and external drive rotor may together have a pot shape, wherein the external drive rotor and the internal drive rotor may extend in an axial direction from the rotor base. The external drive rotor and the rotor base may be produced in one piece. The internal drive rotor may be fastened to the rotor base as an axially extending flange. A base plate which extends substantially in the radial direction can support the drive stator. The base plate, the external drive rotor and the rotor base may substantially form a motor housing.

The drive brake unit preferably comprises a wheel-integrated inverter which is configured to convert vehicle-side direct current into alternating current to the electrical motor. This solution allows cables with a smaller diameter (low-voltage direct current cable) to be used for supplying power to the wheel-integrated electrical motor. This saves further installation space in the region of the wheel suspension/stub axle.

The drive brake unit preferably comprises an active liquid cooling arrangement which comprises a cooling channel in a base plate, which bears a drive stator, of the electrical motor. Active liquid cooling makes it possible for the heat-sensitive components (primarily permanent magnets and the electronics) of the drive brake unit to be protected even better from high temperatures.

The drive brake unit is preferably configured as a direct drive and does not comprise a wheel-integrated transmission.

The object is also achieved by a vehicle comprising at least two drive brake units according to any one of the preceding embodiments.

Further details will emerge from the description of the illustrated exemplary embodiments and from the appended claims.

### BRIEF DESCRIPTION OF THE DRAWINGS

### The drawings show:

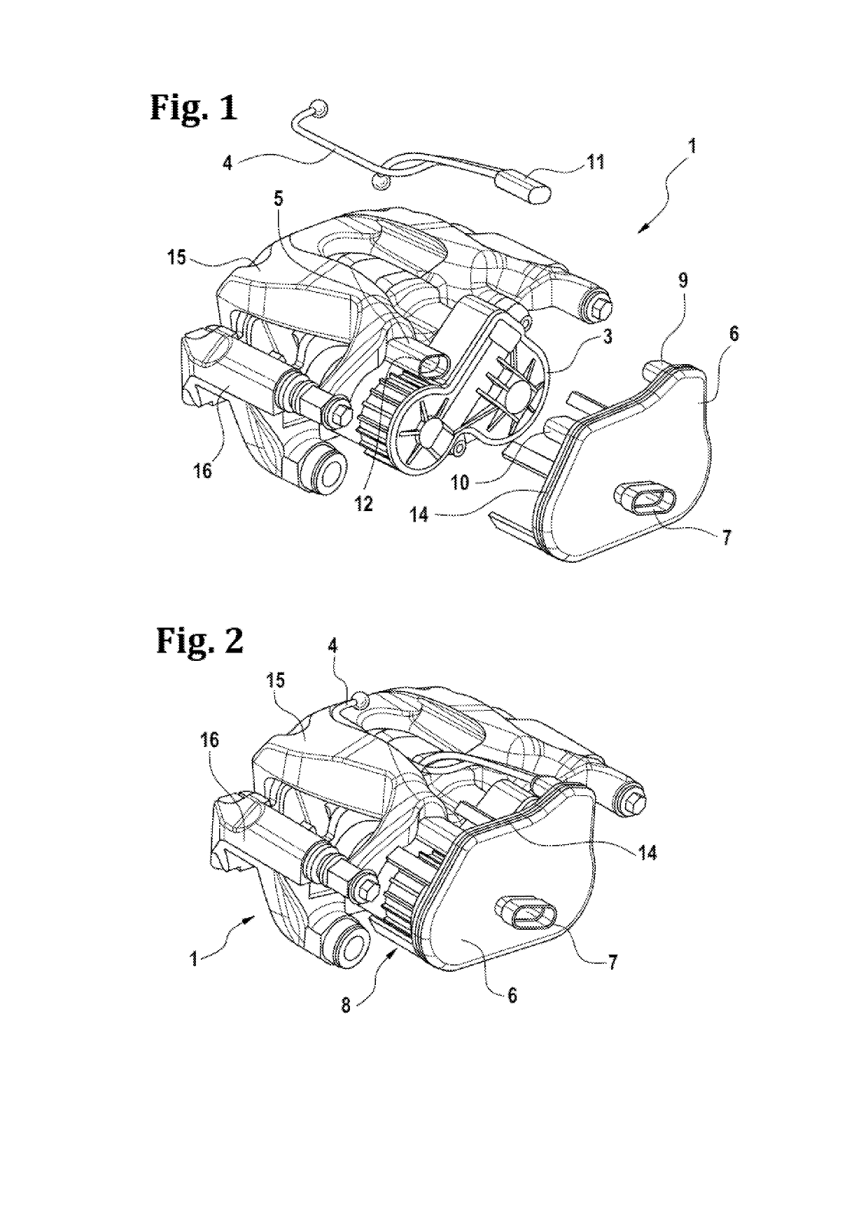

FIG. 1 shows an isometric, partially exploded view of a first embodiment of a friction brake unit, and

FIG. 2 shows an isometric view of the first embodiment corresponding to FIG. 1,

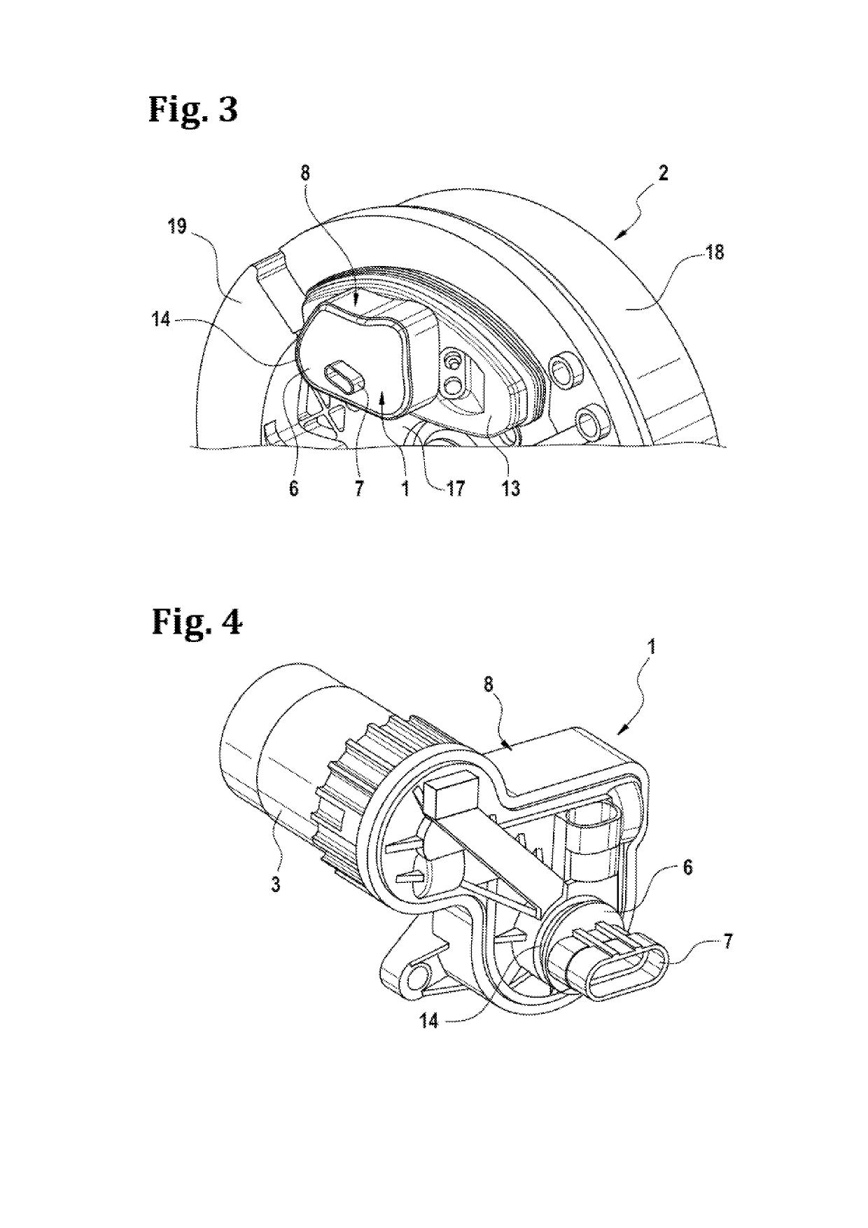

FIG. 3 shows a partial view of a drive brake unit comprising a friction brake unit corresponding to FIGS. 1 and 2, and

FIG. 4 shows an isometric view of a second embodiment of a friction brake unit according to the invention.

In the following detailed description of the embodiments, identical reference numerals denote substantially same or identical parts in or on these embodiments. To better illustrate the invention, the embodiments illustrated in the figures are however not always illustrated to scale.

### DETAILED DESCRIPTION

FIGS. 1-3 show a first embodiment of the friction brake unit 1 according to the invention, while FIG. 4 shows a second embodiment of the friction brake unit 1 according to the invention. Here, in FIG. 3, the friction brake unit 1 is integrated into a drive brake unit 2.

The friction brake unit 1 comprises at least one brake actuator 3 for actuating the friction brake unit and generating a braking torque. The friction brake unit 1 comprises at least two components 4, 5 which are electrically connectable to a vehicle.

In the embodiment illustrated in FIGS. 1 and 2, a component is a lining wear indicator 4. Here, the lining wear indicator 4 is configured such that it can detect wear in both brake linings of a brake caliper.

A further component is an electrically actuatable parking brake device 5 (the reference numeral 5 in FIG. 1 indicates the electrical component connection 12 of the parking brake device 5, since it is integrated into the brake actuator).

The friction brake unit 1 comprises a connection element 6 which has a common connection geometry 7 for the at least two components 4, 5 that can be electrically connected to a vehicle. In FIGS. 1 to 3, the connection element 6 is formed as a housing cover 6, which is a constituent part of a friction brake housing 8.

In the embodiment in FIG. 4, the connection element 6 is integrated into the friction brake housing 8.

As can be seen in FIG. 1, the connection element 6, on a side facing toward the friction brake unit 1, comprises intermediate geometries 9, 10 for at least two of the components 4, 5 which are electrically connectable to a vehicle, and which geometries can be connected to component connections 11, 12 of the components 4, 5. The electrical lines of the intermediate geometries 9, 10 are merged in the connection element 6 in the common connection geometry 7.

In the first embodiment shown in FIGS. 1-3, the friction brake housing 8 of the friction brake unit 1 comprises an elastically deformable seal element 13 (illustrated only in FIG. 3) which permits elastic deformation of the friction brake housing 8 during an actuation of the brake actuator 3. The seal element 13 is in this case formed as an axially extendable bellows. Thus, the connection element 6 is arranged movably together with the elastically deformable seal element 13 and can follow an actuation of the brake actuator 3.

A seal connection geometry 14 is however provided in both embodiments in FIGS. 1-3 and in FIG. 4. In the second embodiment of FIG. 4, the sealing element 13 may for example be a sealing ring (for example O-ring).

Here, the friction brake unit 1 is a disk brake having a brake caliper designed as a floating caliper. The brake caliper comprises an axially displaceable caliper housing 15 and a stationary brake holder 16 for guidance and support.

FIG. 3 illustrates the drive brake unit 2 with integrated friction brake unit 1. A wheel-integrated electrical motor is arranged at least partially axially overlapping with the friction brake unit 1 along a motor axis of rotation.

Here, the friction brake housing 8 of the friction brake unit 1 is sealingly connected to a stator component 17 of the wheel-integrated electrical motor, thus substantially preventing an escape of brake dust from the drive brake unit 2. Here, the stator component 17 is a base plate 17 running substantially in the radial direction. The base plate 17 may for example also support a drive stator with windings or coils for generating an alternating magnetic field of the electrical motor. A drive torque can thus be generated through the interaction of the alternating magnetic field of the drive stator with the magnetic field of permanent magnets arranged on a drive rotor. The base plate 17, an external drive rotor 18 and a rotor base (rear side of FIG. 3, not shown) may substantially form a motor housing. The electrical motor in question is in this case a double-rotor radial flux electrical motor, wherein an internal drive rotor is arranged radially within the drive stator.

The drive brake unit also comprises a wheel-integrated inverter 19, which is configured to convert vehicle-side direct current into alternating current to the electrical motor.

Patent Claims:

1. A friction brake unit for a drive brake unit comprising:
at least one brake actuator for actuating the friction brake unit and generating a braking torque;
at least two components of the friction brake unit are electrically connectable to a vehicle; and
a connection element of the friction brake unit that has a common connection geometry for the at least two components which can be electrically connected to a vehicle.

2. The friction brake unit according to claim 1, wherein the connection geometry is configured such that at least two components can be connected to the vehicle via a single cable.

3. The friction brake unit according to claim 1, wherein a component which is electrically connectable to a vehicle is an electrically actuatable parking brake device.

4. The friction brake unit according to claim 3, wherein the electrically actuatable parking brake device comprises a parking brake actuator which is integrated into a hydraulically actuatable service brake actuator.

5. The friction brake unit according to claim 3, wherein the electrically actuatable parking brake device is integrated into an electromechanically actuatable service brake actuator as a transmission lock.

6. The friction brake unit according to claim 1, wherein a component which is electrically connectable to a vehicle is a lining wear indicator.

7. The friction brake unit according to claim 1, wherein a component which is electrically connectable to a vehicle is a braking force sensor or braking torque sensor.

8. The friction brake unit according to claim 1, wherein the connection element is formed as a housing cover which is a constituent part of a friction brake housing.

9. The friction brake unit according to claim 1, wherein the connection element, on a side facing toward the friction brake unit, comprises intermediate geometries for at least two of the components which are electrically connectable to a vehicle and which are connectable to component connections of the components, wherein the electrical lines are merged from the intermediate geometries in the connection element into the common connection geometry.

10. The friction brake unit according to claim 1, wherein a friction brake housing of the friction brake unit comprises an elastically deformable seal element which permits a movement of the friction brake housing during an actuation of the brake actuator.

11. The friction brake unit according to claim 1, wherein the friction brake unit is a disk brake with a brake caliper designed as a floating caliper.

12. A drive brake unit comprising
a wheel-integrated electrical motor; and
a wheel-integrated friction brake unit comprising:
at least one brake actuator for actuating the friction brake unit and generating a braking torque;
at least two components of the friction brake unit are electrically connectable to a vehicle; and
a connection element of the friction brake unit that has a common connection geometry for the at least two components which can be electrically connected to a vehicle;
wherein the friction brake unit at least partially axially overlaps with the electrical motor along the motor axis of rotation.

13. The drive brake unit according to claim 12, wherein a friction brake housing of the friction brake unit is sealingly connected to a stator component of the wheel-integrated electrical motor, thus substantially preventing an escape of brake dust from the drive brake unit.

14. The drive brake unit according to claim 12, wherein the electric motor is a double-rotor radial flux motor, in which a drive stator is arranged in a radial direction between an external drive rotor and an internal drive rotor, wherein the drive stator comprises coils for generating a magnetic field.

15. The drive brake unit according to claim 12, wherein the drive brake unit comprises a wheel-integrated inverter which is configured to convert vehicle-side direct current into alternating current to the electrical motor.

16. A vehicle comprising at least two drive brake units comprising:
a wheel-integrated electrical motor; and
a wheel-integrated friction brake unit comprising:
at least one brake actuator for actuating the friction brake unit and generating a braking torque;
at least two components of the friction brake unit are electrically connectable to a vehicle; and
a connection element of the friction brake unit that has a common connection geometry for the at least two components which can be electrically connected to a vehicle;
wherein the friction brake unit at least partially axially overlaps with the electrical motor along the motor axis of rotation.
